(19) United States
(12) Patent Application Publication
(10) Pub. No.: US 2007/0125009 A1
(43) Pub. Date: Jun. 7, 2007

(54) Suspended display apparatus

(75) Inventors: Paul Belokin, Denton County, TX (US); Martin P. Belokin, Denton County, TX (US); Norman P. Belokin, Denton County, TX (US)

Correspondence Address: JACK A. KANZ, 502 SOUTH COTTONWOOD DRIVE, RICHARDSON, TX, 75080, US

(73) Assignee: Displays by Martin Paul, Inc.- Creative Center

(21) Appl. No.: 11/271,226

(22) Filed: Nov. 14, 2005

(51) Int. Cl. G09F 7/18

(52) U.S. Cl. 52/39

(57) ABSTRACT

Apparatus for displaying merchandise is suspended from overhead ceiling structures. The display apparatus includes a suspension strand supported by a support hook which attaches to the ceiling support grid members of a drop-style ceiling. The support hook is locked into place on the support grid member by the ceiling tile. Promotional graphic displays and/or merchandise may be supported on the hook structures secured to the suspension strand.

This invention relates to methods and apparatus for holding and displaying merchandise. More particularly, it relates to assemblies suspended from overhead structure of a retail store or the like and used to display merchandise, thereby utilizing formerly unused space and providing ready customer access to the displayed goods.

Various constructions of display arrangements such as multi-faceted display stands provided with one or more shelves, bins, receptacles or the like for goods to be displayed are widely used. Display stands of this type are intended for use in store aisles and at similar locations where potential customers may approach the display stand from different directions or move about the stand to examine the goods on display and have ready access for removal and purchase.

Convenience stores have highly refined the art of displaying the maximum amount of goods in the minimum amount of floor space. Such stores typically have several aisles of open shelf displays, a number of refrigerated sections behind glass doors and counter space for hot and cold drink dispensers and unpackaged goods such as doughnuts and the like. The open shelf displays, however, are rarely over five feet in height and the space above counters is generally unused. Thus, there remain substantially large amounts of space above the shelves in such stores which are not used for display of goods or advertising because display assemblies for holding and displaying goods or advertising displays in the open space above counters, above display shelves and elsewhere have not herefore been available. Convenience stores generally do not have floor space to spare for the typical floor-mounted display stands used by larger supermarkets, hardware stores and the like, but often have large amounts of open space above and between aisles of fixed display shelves which are unused or underutilized.

Convenience stores typically have overhead structures comprising drop-style suspended ceilings which use a grid of supports spanning the ceiling space. Such drop-style suspended ceilings include a plurality of parallel supports suspended from the interior superstructure of the building. The support members are generally in the shape of an inverted T having horizontal base portions supported by a vertical portion. Ceiling tiles are supported on the grid of support members. Spacing of grid supports is standardized and the standard grid pattern provides adequate support for the suspended displays contemplated herein.

Most prior suspension apparatus for display of merchandise has been unsatisfactory for a variety of reasons. Most lack either adequate support and/or stability. Some are difficult to assembly and use and some are simply too expensive to be of practical use. A need thus exists for apparatus which promotes display of merchandise in the space above floor stands, counter tops, fixed display shelves and in other open spaces which overcomes the deficiencies of prior devices. The displays must provide product and/or promotion presentation at a position convenient for customer access and, preferably, act in a manner to attract the attention of the customer. However, the display assembly must be easy to assemble and use and must be inexpensive and reliable. The displays must also be adaptable to display various types of merchandise without major modification of the display apparatus and should provide easily removable and changeable advertising graphics and the like for promotion of the merchandise displayed.

In accordance with the present invention display apparatus is provided which includes a flexible suspension strand suspended from overhead structure and supporting a plurality of product display hooks. The suspension strand is preferably link chain or the like made of suitable lightweight material such as plastic. The suspension strand is supported from the ceiling grid support by a connector attached to the base of the grid support member and locked into place by the ceiling tiles. In the preferred embodiment, the connector incorporates a display panel for advertising graphics or the like. Display hooks incorporated into the suspension strand or interconnected therewith provide means for suspending and displaying advertising graphics and/or products individually or in pre-packaged arrangements. The display hooks may be removably attached to the suspension strand to permit mounting the hooks at adjustably variable elevations on the suspension strand so that the product may be supported and displayed at any convenient level. By suspending the display apparatus from overhead structure, the display apparatus of the invention may be conveniently positioned to take advantage of otherwise unused space and present merchandise in a convenient location for customer access. The novel display apparatus thus supports and presents merchandise products and/or advertising materials at convenient customer access positions in a place of business. The suspended display apparatus takes advantage of space above counter tops, etc., which is otherwise unused and, since it is suspended, permits movement to attract customers. The apparatus of the invention is formed of simple, inexpensive mass-produced parts which can be easily and readily assembled into useable display assemblies which may be disassembled and reconfigured as desired to display a wide variety of products and materials in otherwise unused space.

Other features and advantages of the invention will become more readily understood from the following detailed description taken in connection with the appended claims and attached drawing in which:

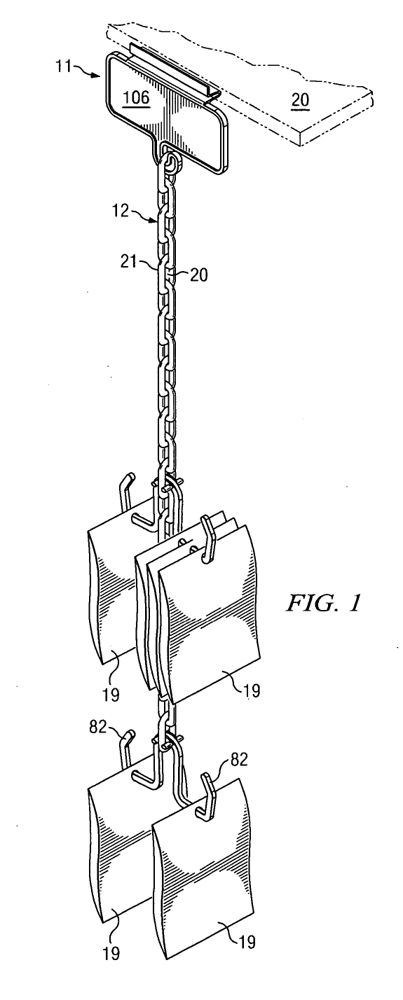

FIG. 1 is a perspective view of a preferred embodiment of apparatus for supporting and displaying merchandise in accordance with the invention;

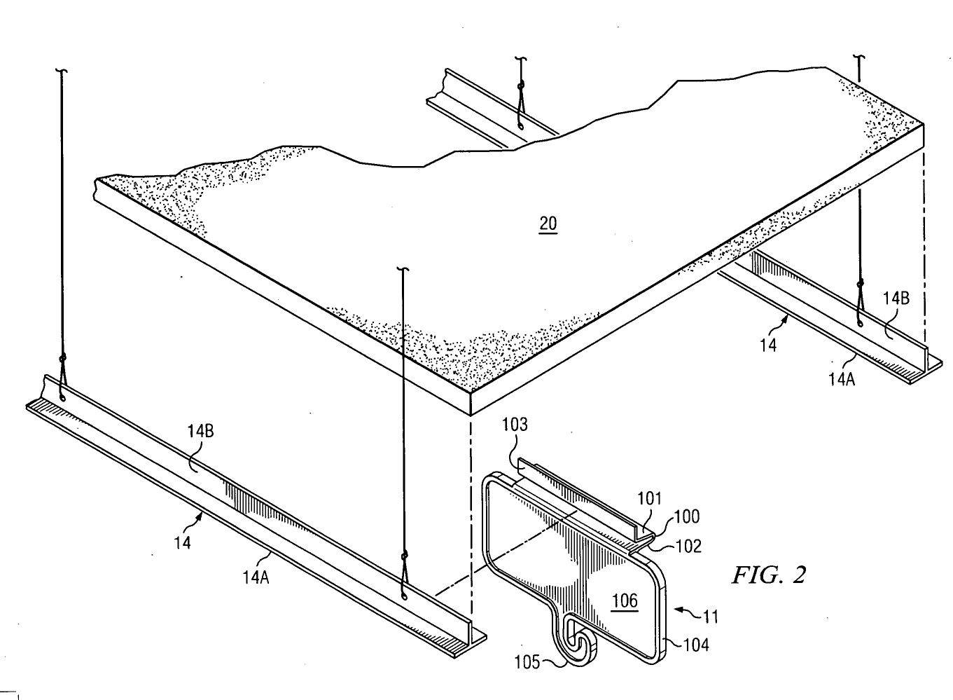

FIG. 2 is an exploded view of the ceiling support grid illustrating attachment of the support connector of the apparatus of the invention;

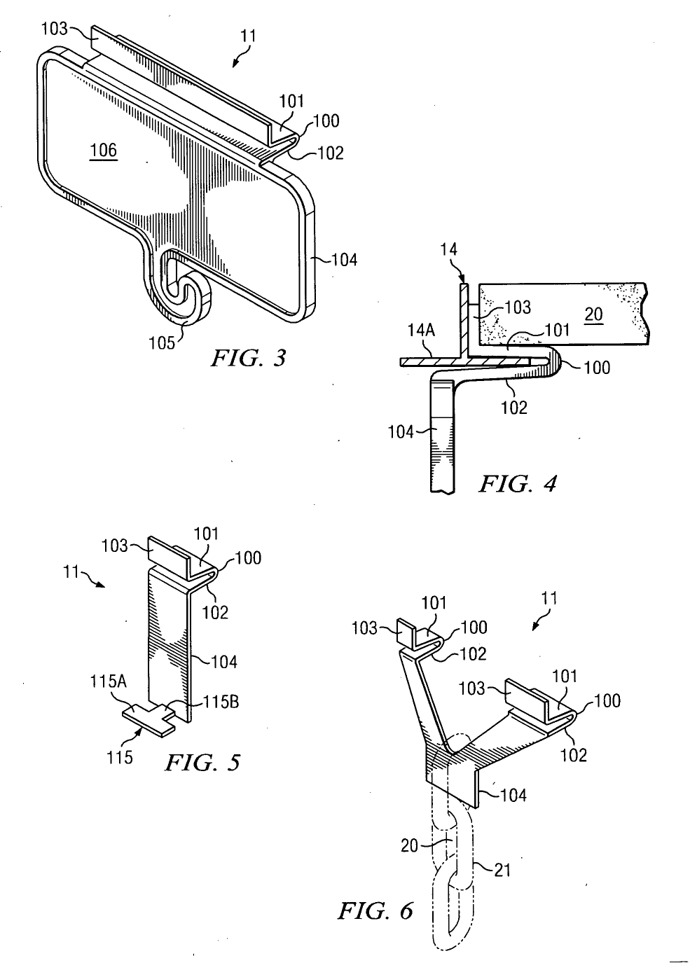

FIG. 3 is a perspective view of one embodiment of a support connector for supporting the apparatus shown in FIG. 1;

FIG. 4 is a side view of the support connector of FIG. 3 illustrating placement of the support connector on the ceiling support grid;

FIG. 5 is a perspective view of an alternative embodiment of a support connector of the invention;

FIG. 6 is a perspective view of another alternative embodiment of a support connector of the invention;

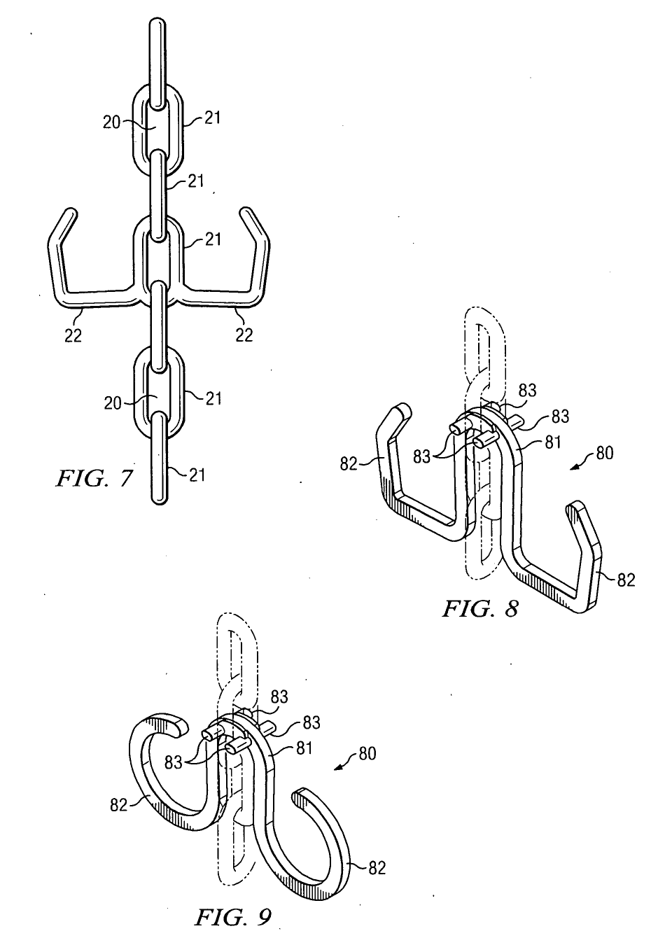

FIG. 7 is a front elevational view of one embodiment of suspension strand which incorporates a product support hook;

FIG. 8 is a perspective view of an alternative embodiment of a product hook; and

FIG. 9 is a perspective view of another alternative embodiment of a product hook.

The drawing is incorporated into and forms part of the specification to illustrate exemplary embodiments of the invention. For clarity of illustration, like reference numerals designate corresponding elements throughout the drawing. It will be recognized that the principles of the invention may be utilized and embodied in many and various forms. In order to demonstrate these principles, the invention is described herein by reference to specific preferred embodiments. The invention, however, is not limited to the specific forms illustrated and described in detail.

While the invention is described and illustrated herein as apparatus for supporting and displaying “merchandise,” “product,” etc., these terms are intended to be given their broadest possible meaning and may include anything from food products to beverages to hardware and the like, packaged or unpackaged. Likewise, the term “hook” is used in its broadest sense to mean any receptacle on or through which merchandise or promotional material may be supported or suspended. Similarly, spatial orientation and directional terms such as “upwardly,” downwardly,” “horizontally,” “laterally,” “inner,” “outer,” “above,” below,” etc., are used in their normal sense in reference to the apparatus of the invention oriented in its normal intended use position.

A preferred embodiment of the invention is illustrated in FIG. 1 with the display assembly supported from conventional overhead drop-style ceiling structure. In the embodiment of FIGS. 1-4 a suspension strand 12 (illustrated as link chain) is suspended from a standard drop ceiling support grid 14 with a preferred embodiment of a support connector 11 of the invention. The upper portion of support connector 11 is in the shape of a U with substantially parallel horizontally extending sides 101 and 102 connected by a base 100. Top side 101 is spaced from bottom side 102 a sufficient distance to permit the horizontally projecting base 14A of the ceiling support grid member 14 to fit therebetween (see FIG. 2). A locking lip or flange 103 projects upwardly from the free end of top side 101 and a support shank 104 depends from the free end of bottom side 102. As illustrated in FIG. 4, the length of top side 101 should be sufficient to permit the horizontally projecting base 14A of ceiling support grid 14 to project into the space between top side 101 and bottom side 102 and permit flange 103 to be positioned adjacent the vertically extending portion 14B of ceiling support grid member 14. In the preferred embodiment, the bottom side 102 is at least as long as the top side 101 and the support shank 104 depends from the free end (or near the free end) of bottom side 102. In this configuration the weight supported by support shank 104 is suspended approximately directly below the vertically extending portion 14B of ceiling support grid member 14 to avoid imparting an unnecessary twisting load on the ceiling support grid member 14.

A support hook 105 depends from support shank 104 and is adapted to engage the upper end of flexible strand 12. In the embodiment of FIGS. 1-4 the support hook 105 is simply a hook structure adapted to engage the vertically elongated aperture 20 in the end link 21 of the link chain suspension strand 12 and thus support the suspension strand 12 and anything attached thereto.

In the embodiment shown in FIGS. 1-4 the shank 104 is in the form of an enlarged disc or plate having a relatively large flat surface 106 which may be used to support or display advertising graphics and the like. Obviously, the enlarged portion may be used to support active or passive displays and may be shaped as desired.

As illustrated in FIGS. 1-4 the support connector 11 is secured to the ceiling support grid member 14 by inserting the base portion 14A of the grid support member 14 between the top side 101 and the bottom side 102 to position the locking flange 103 parallel with and adjacent the vertically extending portion 14B of the grid member 14. Ceiling tile 20 is then lowered into place in its normal position between parallel grid support members 14. When so positioned, the ceiling tile 20 rests on the top surface of top side 101 of the support connector 11 and adjacent the locking flange 103. The ceiling tile 20 thus locks the support connector 11 in place and prevents undesired movement or removal of the support connector 11. Since the support connector 11 is supported on the grid support member 14 and locked into place by the ceiling tile 20, the support connector 11 may be placed at any desired location in a conventional drop-style ceiling installation quickly and easily without necessity of using any tools or the like. It will be appreciated that the suspension strands 12 may thus depend from selected positions in overhead structure to traverse space which is ordinarily and otherwise unoccupied.

In the embodiment illustrated suspension strand 12 is link chain or the like made from lightweight materials such as plastic. Such lightweight plastics provide suitable tensile strength to support the display and may be advantageously formed of colored materials, if desired. The suspension strand 12 is preferably formed of interconnected links 21 to permit the strand to flex. Such interconnected links also advantageously provide a vertically extended aperture 20 in each link 21 which permits convenient attachment of display hooks for supporting and displaying product and/or advertising materials thereon. Suspension strands 12 may be formed in other flexible configurations or may be in the form of cables or ropes provided with loops or other attachments which provide an aperture for mounting product display hooks.

Alternative embodiments of the support connector 11 are illustrated in FIGS. 5 and 6. In the embodiment of FIG. 5 the shank 104 and the U-shaped upper end of the support connector are formed from a single strip of metal or other suitable material and the width of the shank 104 is substantially the same width as the remainder of the support connector. In this embodiment the support hook is in the form of a T-shaped tab 115. Tab 115 has an expanded head 115A supported on a laterally projecting stub 115B. The lateral length of head 115A is wider than the horizontal width of vertically elongated aperture 20 in chain link 21 and shorter than the vertical length of aperture 20. The stub 115B is no wider than the horizontal width of the aperture 20. Accordingly, the link chain suspension strand 12 may be secured to the support connector 11 of FIG. 5 by rotating a link 21 90° (so that the elongated aperture extends horizontally) and inserting head 115A through the aperture 20. When the link 21 is re-oriented to extend vertically, the link chain is supported in stub 115B and retained thereon by head 115A.

In the embodiment of FIG. 6 the U-shaped body portion and the upper portion of shank 104 are separated to form a V-shaped shank 104. The U-shaped body and at least one side of the V-shaped shank 104 are sized and shaped sufficiently small to pass through an aperture (such as aperture 20) in the end of the suspension strand 12. Accordingly, the support connector 11 of FIG. 6 is attached to the suspension strand 12 before the support connector is attached to the ceiling support grid member 14 by passing one side of the V-shaped support connector through an aperture in the suspension strand. The U-shaped ends are then attached to the ceiling support grid member 14 as described above and the suspension strand 12 is supported on the base of shank 104 where the two sides of shank 104 are joined.

The product hook may take many various forms. In the embodiment illustrated in FIG. 7, the product hook is in the form of outwardly extending members 22 integrally formed as a part of one of the interconnected links 21 in a link chain suspension strand 12.

Removable product hooks are illustrated in FIGS. 8 and 9. In these embodiments the product hook 80 comprises a serpentine body having a central portion 81 adapted to pass through the vertically elongated aperture 20 in chain link 21. Hook-like members 82 depend downwardly, outwardly and upwardly from central portion 81 to form hook structures 82 on opposite sides of suspension strand 12 for supporting packaged product 19 or the like as illustrated in FIG. 1. The hook structures 82 may take any desired shape or size, such as the broad open hooks shown in FIG. 8, the smaller curved hooks shown in FIG. 9, or any other desired shape.

In the preferred embodiment the central portion 81 of the product hooks 80 include retainer posts 83. Posts 83 are formed in pairs with each pair extending laterally in opposite directions from the central position 81. The posts 83 on each side of the central portion 81 are separated by a distance substantially equal to the thickness of a chain link 21. Accordingly, the central portion 81 may be positioned within an aperture 20 in a chain link 21 so that the pair of posts 83 on each side thereof are positioned to retain one side of chain link 21 therebetween. The retainer posts 83 thus securely but removably maintain the serpentine body of product hooks in a fixed position within the chain link 21.

As illustrated in FIG. 1, packages of merchandise (or display apparatus) may be supported on the hook structures 82. Advertising material or other display apparatus may also be supported on the suspension strands 12. As noted above, the support connectors 11 may be attached at any desired location on the ceiling support grid members 14 and locked into place with the ceiling tile 20. Removable product hooks (such as illustrated in FIGS. 8 and 9) may be positioned as desired on the suspension strand 12. Accordingly, the entire display assembly may be assembled and suspended in the desired position quickly and easily with using any tools.

All components of any of the various designs of apparatus for practicing the invention may be fabricated and assembled using readily available materials and manufacturing techniques. Furthermore, many suitable structures are readily and inexpensively available for use as the suspension strands of the invention, and all components may be readily manufactured using any of a wide variety of suitable materials.

While only exemplary embodiments of the invention have been illustrated and described in detail herein, it will be readily recognized that the principles of the invention may be used in various forms using a wide variety of components assembled in accordance with the teachings of this invention to achieve the benefits and advantages thereof. It is to be understood, therefore, that even though numerous characteristics and advantages of the invention have been set forth in the foregoing description together with details of the structure and function of the various embodiments, this disclosure is to be considered illustrative only. Various changes and modifications may be made in detail, especially in matters of shape, size, and materials as well as arrangement and combination of parts, without departing from the spirit and scope of the invention as defined by the appended claims.

What is claimed:

1. Apparatus for supporting and displaying merchandise comprising:
(a) a flexible suspension strand;
(b) a product hook supported on said suspension strand; and
(c) a support connector adapted to be attached to a ceiling support grid member and comprising:
(i) a body having a top side member and a substantially parallel bottom side member, each side member having a first end and a second end with the first ends of said top side member and said bottom side member joined to form a substantially U-shaped body;
(ii) a flange extending upwardly from the second end of said top side member;
(iii) a shank depending downwardly from said bottom side member; and
(iv) means depending from said shank adapted to engage and support said flexible suspension strand.

2. Apparatus as defined in claim 1 wherein said suspension strand includes apertures extending laterally therethrough.

3. Apparatus as defined in claim 2 wherein said product hook extends through and is secured in one of said apertures.

4. Apparatus as defined in claim 1 wherein said suspension strand comprises a chain of elongated interconnected links.

5. Apparatus as defined in claim 4 wherein said product hook is an outwardly extending member integrally formed as part of one of said interconnected links.

6. Apparatus as defined in claim 4 wherein said product hook extends through and is secured to one of said interconnected links.

7. Apparatus as defined in claim 1 wherein said shank includes an enlarged surface.

8. Apparatus as defined in claim 7 including promotional graphics displayed on said enlarged surface.

9. Apparatus as defined in claim 1 wherein said means depending from said shank comprises T-shaped tab having an expanded head supported on a laterally projecting stub.

10. Apparatus for supporting and displaying merchandise comprising:
(a) a flexible suspension strand;
(b) a product hook supported on said suspension strand; and
(c) a support connector connected to and supporting said flexible suspension strand and adapted to be attached to a ceiling support grid member comprising:
(i) a shank comprising two side portions separated at their top ends and joined at their bottom ends to form a base; and
(ii) a U-shaped body formed in the top end of each of said side portions, each U-shaped body having a top side member and a substantially parallel bottom side member, each side member having a first end and a second end with the first ends of said top side member and said bottom side member joined to form a substantially U-shaped body; and
(iii) a flange extending upwardly from the second end of said top side member.

11. Apparatus as defined in claim 10 wherein said suspension strand has an aperture in one end thereof and one side portion of said shank is inserted into said aperture to support said suspension strand on said base.

12. A hook structure for attachment to and support product on a flexible suspension strand having an aperture therein comprising:
(a) a central body;
(b) hook-like structures depending downwardly, outwardly and upwardly from said central body; and
(c) means for fixedly securing said central body in said aperture in said flexible suspension strand.

13. Hook structure as defined in claim 12 wherein;
(a) said flexible suspension strand is a chain comprising interconnected elongated links, each link having an aperture therein;
(b) said central body is positioned in the aperture of one of said elongated links; and
(c) said means for fixedly securing said central body comprises a pair of retainer posts extending laterally from said central portion and on opposite sides of said elongated link.

14. Hook structure as defined in claim 12 wherein;
(d) said flexible suspension strand is a chain comprising interconnected elongated links, each link having an aperture therein;
(e) said central body is positioned in the aperture of one of said elongated links; and
(f) said means for fixedly securing said central body comprises a pair of retainer posts extending laterally and in opposite directions from each side of said central portion with each pair positioned on opposite sides of said elongated link.
